(19) United States
(12) Patent Application Publication
(10) Pub. No.: US 2003/0026424 A1
(43) Pub. Date: Feb. 6, 2003

(54) System, method and computer program product for delivery and utilization of content over a communications medium

(75) Inventors: Roger K. McGarrahan, Southwick, MA (US); Brett Evan Jenkins, West Springfield, MA (US); Brian Scott Murtari, Enfield, CT (US); Edward M. Karam, Springfield, MA (US); Donnell M. Heyse, Suffield, CT (US); John D. Isham, Feeding Hills, MA (US)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: THALES BROADCAST & MULTIMEDIA, INC., Southwick, MA

(21) Appl. No.: 10/066,570

(22) Filed: Feb. 6, 2002

Related U.S. Application Data
(60) Provisional application No. 60/266,488, filed on Feb. 6, 2001.
(60) Provisional application No. 60/216,769, filed on Jul. 7, 2000.

(51) Int. Cl. H04K 1/00

(52) U.S. Cl. 380/255

(57) ABSTRACT

A system, method and computer program product, for distributing content over a terrestrial broadcast channel including a broadcast station configured to transmit over the terrestrial broadcast channel a television signal including encrypted updated content information, distributed at least one of nationally and locally, and television information to all users within a broadcast coverage area; and an apparatus pre-configured to include encrypted predetermined content information stored therein prior to acquisition of the apparatus by a user and configured to: receive over the terrestrial broadcast channel the television signal, extract the encrypted updated content information from the television signal, store the encrypted updated content information in the apparatus, decrypt the updated encrypted content information and the encrypted predetermined content information, and provide on demand at least one of the decrypted updated content information and the decrypted predetermined content information in a format for at least one of a television, a data processing device and a gaming device. The encrypted updated content information and the encrypted predetermined content information includes at least one of encrypted digital movies, encrypted video games and encrypted MPEG Audio Layer 3 (MP3) files.

### CROSS REFERENCE TO RELATED PATENT DOCUMENTS

This document contains subject matter related to that described in U.S. Pat. No. 6,023,612 and U.S. Provisional Patent Application No. 60/216,769, the entire contents of both of which are incorporated by reference herein. This application is entitled to the benefit of the earlier filing date of U.S. Provisional application serial No. 60/266,488, filed Feb. 6, 2001, the entire contents of which being incorporated herein by reference.

### BACKGROUND OF THE INVENTION

1. Field of the Invention

The present invention generally relates to the field of communications and more specifically to a method, system and computer program product for delivery and utilization of content over a communications medium. The present invention includes use of various technologies described in the references identified in the appended LIST OF REFERENCES and cross-referenced throughout the specification by numerals in brackets corresponding to the respective references. The entire contents of each reference in the appended LIST OF REFERENCES are incorporated herein by reference.

2. Discussion of the Background

Currently, consumers primarily obtain new release movies (i.e., those released for viewing subsequent to showing at theaters) by traveling to video stores to rent movies or by renting them near-video-on-demand (NVOD) via cable or satellite. Digital cable and Digital Subscriber Line (DSL) providers have recently pursued delivery of movies to the home on-demand, often referred to as video-on-demand (VOD). In this respect, a leading video store rental chain recently announced its intentions to pursue the delivery of its video content via DSL, [1] recognizing that its traditional business model will be threatened by the roll out of VOD over DSL, digital cable and/or satellite.

In the above respect, the roll out of VOD over DSL, digital cable and/or satellite will gradually erode the “in store” rental model of video store rental chains. If the video store rental chains do not participate in a VOD model, they have a limited future. It appears that the video store rental chains have chosen to pursue delivery of VOD services via DSL instead of cable or satellite to avoid partnering with the incumbent (and competing) cable and satellite content companies. Instead, such video store rentals chain can team with telecommunications companies who are not currently competitors and who are anxious to generate revenue from their existing, but not fully utilized, broadband pipe.

However, all of the above-noted models for delivering VOD have inherent limitations with respect to efficiency and capital and operation costs and such problems are addressed by the present invention.

### SUMMARY OF THE INVENTION

Accordingly, an object of this invention is to provide a novel system, method and computer program product for delivery and utilization of content over a communications medium with increased efficiency and reduced capital and operation costs.

The above and other objects are achieved according to the present invention by providing a novel system, method and computer program product, for distributing content over a terrestrial broadcast channel including a broadcast station configured to transmit over the terrestrial broadcast channel a television signal including a broadcast station configured to transmit over the terrestrial broadcast channel a television signal including encrypted updated content information, distributed at least one of nationally and locally, and television information to all users within a broadcast coverage area; and an apparatus pre-configured to include encrypted predetermined content information stored therein prior to acquisition of the apparatus by a user and configured to: receive over the terrestrial broadcast channel the television signal, extract the encrypted updated content information from the television signal, store the encrypted updated content information in the apparatus, decrypt the updated encrypted content information and the encrypted predetermined content information, and provide on demand at least one of the decrypted updated content information and the decrypted predetermined content information in a format for at least one of a television, a data processing device and a gaming device. The encrypted updated content information and the encrypted predetermined content information includes at least one of encrypted digital movies, encrypted video games and encrypted MPEG Audio Layer 3 (MP3) files.

In another aspect of the present invention, there is provided a novel apparatus, method and computer program product therefor corresponding to the above-noted system.

In another aspect of the present invention, there is provided a novel broadcast station, method and computer program product therefor corresponding to the above-noted system.

### BRIEF DESCRIPTION OF THE DRAWINGS

A more complete appreciation of the invention and many of the attendant advantages thereof will be readily obtained as the same becomes better understood by reference to the following detailed description when considered in connection with the accompanying drawings, wherein:

FIG. 1 is a system diagram illustrating an exemplary system for delivering content, according to the present invention;

FIG. 2 is a block diagram illustrating an exemplary set-top box used in the system of FIG. 1, according to the present invention;

FIG. 3 is a block diagram illustrating an exemplary local station studio used in the system of FIG. 1, according to the present invention;

FIG. 4a is a flow chart illustrating the transmission scheme for delivering content, according to the present invention;

FIG. 4b is a flow chart illustrating the reception scheme for receiving content, according to the present invention; and

FIG. 5 is a schematic illustration of a general-purpose microprocessor-based or digital signal-processor-based system, which can be programmed according to the teachings of the present invention.

### DESCRIPTION OF THE PREFERRED EMBODIMENTS

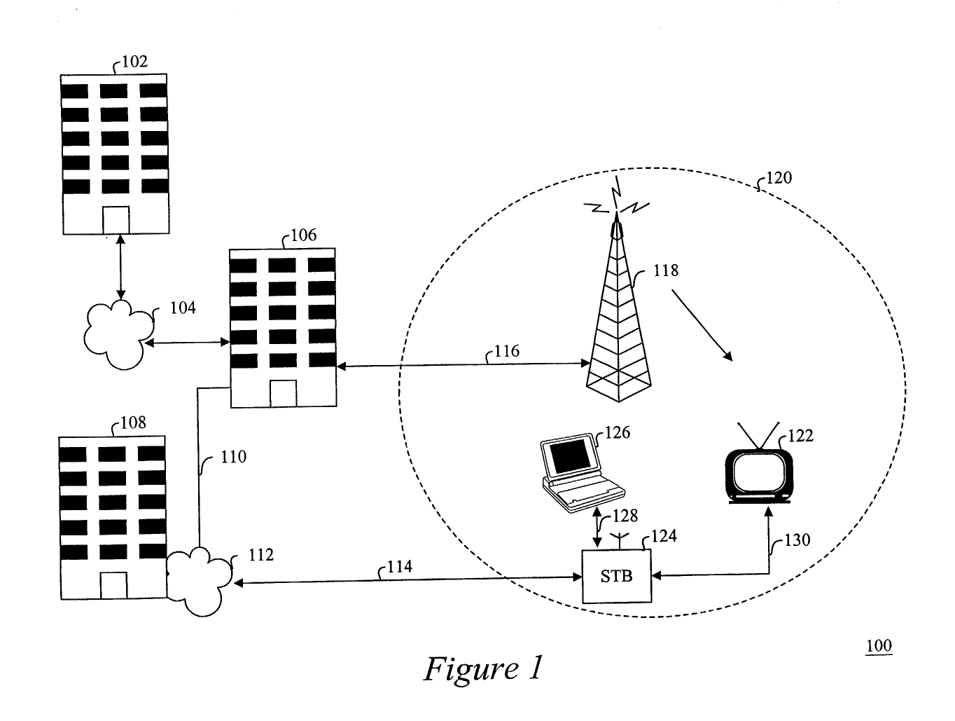

Referring now to the drawings, wherein like reference numerals designate identical or corresponding parts throughout the several views, and more particularly to FIG. 1 thereof which illustrates a system 100, according to the present invention.

In FIG. 1, in the system 100 according to the present invention, a content control and distribution provider 102 transmits content information to a local station studio 106 via a communications network 104. The local station studio 106 then formats the content information and transmits the formatted content information 116 to a set-top box (STB) 124 within a transmission area 120 of a transmitter 118. Television 122 is coupled to the set-top box 124 via signal lines 130. The STB 124 may also be coupled to a data device 126, such as a personal computer, personal digital assistant (PDA), etc., via signal lines 128.

The data device 126 and the television 122 thus are able to receive the content information and make requests for content information via the STB 124. The STB 124 transmits billing and ordering information and sends content information requests as information on signal lines 114 via, for example, a telephone company 108 and a public switched telephone network (PSTN) 112, etc. The telephone company 108 then forwards the information from signal lines 114 to the local station studio 106 on signal lines 110 via the PSTN 112. With the above-noted system, video-on-demand, audio-on-demand, etc., are possible, as will be further described.

One or more interface mechanisms may be used in the system 100, for example, including Internet access, telecommunications in any form (e.g., voice, modem, etc.), wireless communications media, etc., via communication networks 104 and 112. The system 100 information also may be transmitted via direct mail, hard copy, telephony, etc., when appropriate.

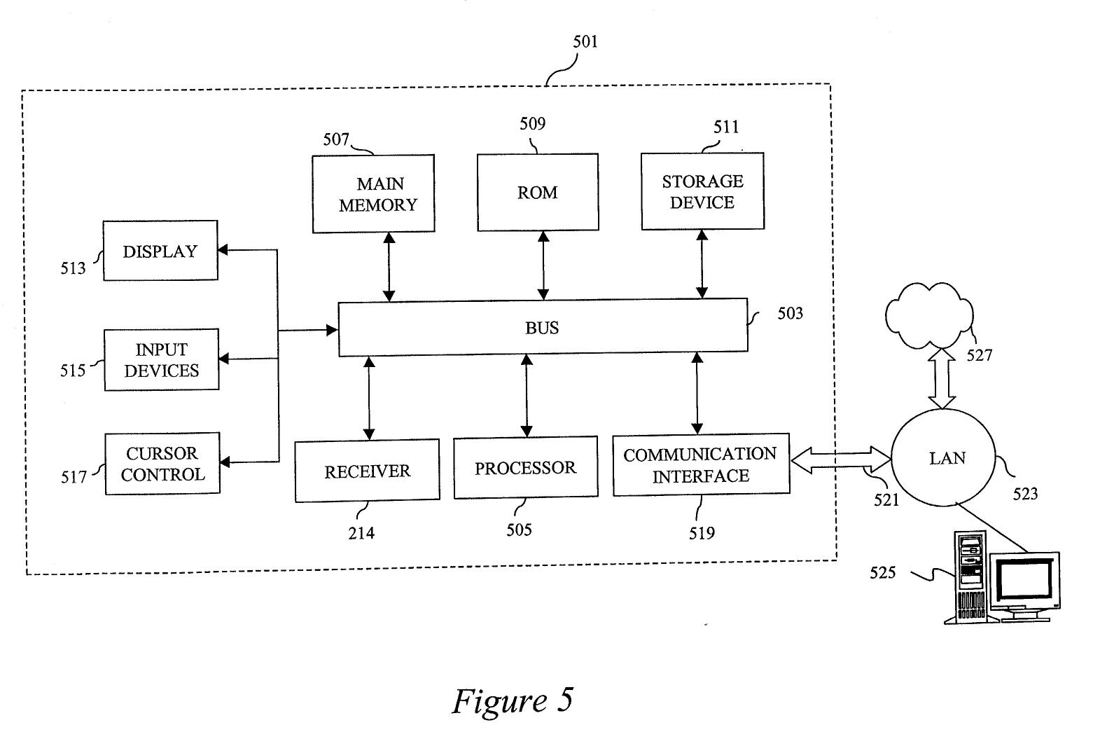

Accordingly, the systems 102, 106, 108, and 124 may include any suitable servers, workstations, personal computers (PCs), personal digital assistants (PDAs), other devices, etc., capable of performing the processes of the present invention. The systems 102, 106, 108, and 124 communicate with each other using any suitable protocol and may be implemented using the computer system 501 of FIG. 5, for example.

It is to be understood that the system in FIG. 1 is for exemplary purposes only, as many variations of the specific hardware/software used to implement the present invention are possible, as will be appreciated by those skilled in the relevant art(s). For example, the functionality of the one or more of the systems 102, 106, 108, and 124 may be implemented via one or more programmed computers or devices. To implement such variations as well as other variations, a single computer (e.g., the computer system 501 of FIG. 5) may be programmed to perform the special purpose functions of, for example, one or more of the systems 102, 106, 108, and 124 shown in FIG. 1. On the other hand, two or more programmed computers or devices may be substituted for any one of the systems 102, 106, 108, and 124 shown in FIG. 1. Principles and advantages of distributed processing, such as redundancy and replication, may also be implemented as desired to increase the robustness and performance of the system 100, for example.

The communications networks 104 and 112 may be implemented via one or more communications networks (e.g., the Internet, an Intranet, satellite communications network, wireless communications network, a telephony communications network, a combination thereof, etc.), as will be appreciated by those skilled in the relevant art(s). In a preferred embodiment of the present invention, the communications network(s) preferably use electrical, electromagnetic, or optical signals that carry digital data streams.

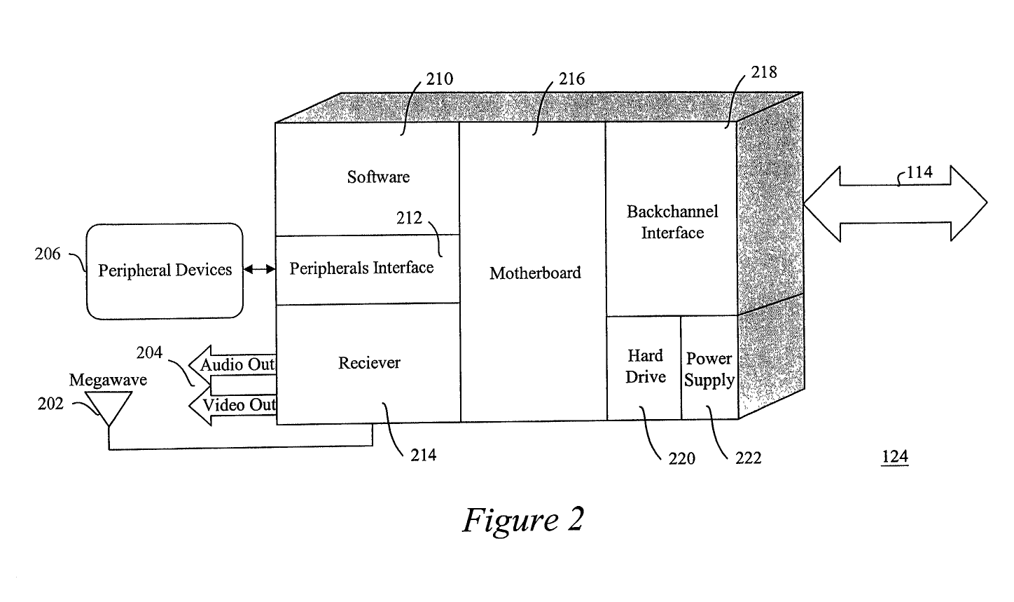

FIG. 2 is a block diagram illustrating an exemplary set-top box 124 used in the system of FIG. 1, according to the present invention. In FIG. 2, the set-top box 124, for example, includes software 210, a peripherals interface 212 (e.g., USB, RF, IEEE 1394, etc.), a receiver 214 including a video driver and Conditional Access System (CAS), e.g., for limiting content viewing to subscribing audiences, blocking any other access to the content data, etc. (implemented using, e.g., a Hauppauge, BroadLogic, etc., receiver card), a motherboard 216 (e.g., PC 104, 500 MHz Intel Pentium III, 64 MB RAM, IDE controller, USB controller, serial controller, NIC, IR, VGA output, PCI slots, etc.), a backchannel interface 218 (e.g., LAN/WAN (NIC), modem (PSTN), cellular, custom transceiver, etc.), a hard drive 220 (e.g., 80+GB), a power supply 222 and an antenna 202 (e.g., Megawave, etc.). The peripherals interface 212 is also configured to allow external gaming systems (e.g., N64, Sega, Sony, PlayStation, Ncube, etc.) to be connected to a port provided in the set top box 124, allowing video games to be played directly on the external gaming systems via the set top box 124.

The backchannel interface 218 is coupled to the signal lines 114 and, for example, transmits user requests, sends and receives billing information, etc. (e.g., via cable modem interfacing, DSL modem interfacing, wireless communications interfacing, 1-800 number interfacing, telephony interfacing, modem interfacing, guard band interfacing, etc.). The peripherals interface 212 is coupled to one or more peripheral devices 206 (e.g., remote controller, keyboard, mouse, game controller, etc.). The software 212 provides, for example, a man-machine interface (MMI) (e.g., implemented as a graphical user interface (GUI)), a billing database, an operating system (OS), drivers, etc. The receiver demodulates content received over the antenna 202 and outputs the content on audio/video signal lines 204 (e.g., in AC-3, DTS, etc., audio format and in standard TV, HDTV, SVHS, etc., video formats).

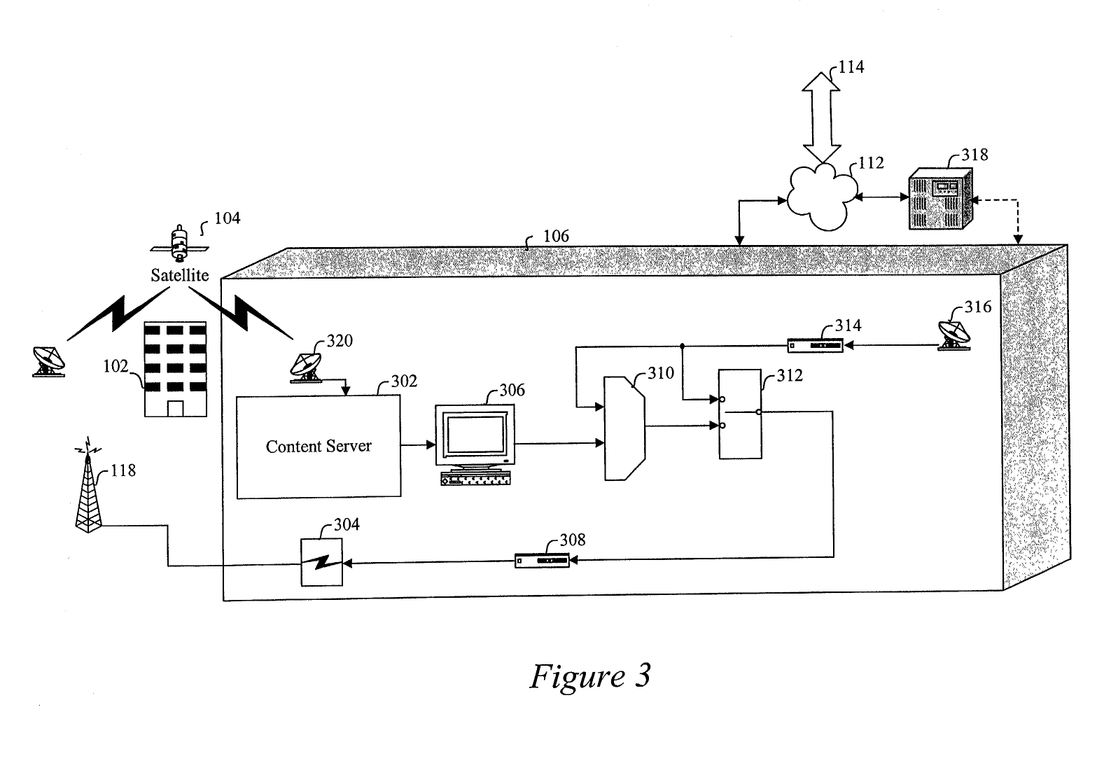

FIG. 3 is a block diagram illustrating an exemplary local station studio 106 used in the system of FIG. 1, according to the present invention. In FIG. 3, the local station studio 106, for example, includes a content satellite receiver 320, a content server 302 (e.g., providing storing of videos, content encryption, local advertisement insertion (e.g., for displaying before or after content is displayed on the set top box 124, etc.), forward error correction (FEC) (e.g., Block CRC, etc), preview insertion, scheduling (e.g., via carousel), games, audio (e.g., MPEG Audio Layer 3 (MP3) files, etc.), etc.), an Internet Protocol (IP) to Moving Pictures Experts Group (MPEG) encapsulator (e.g., OPAL, etc.) and Program and System Information Protocol (PSIP) (e.g., Pearl, etc.) 306, a re-multiplexer 310 (e.g., Amber, etc.), a switch 312 (e.g., Amethyst, etc.), stream converters 314 and 308 (e.g., Turquoise, etc.), a satellite digital television (DTV) receiver 316 and a high-power amplifier 304 (e.g., STL, etc.).

The local station studio 106 receives content from the content control and distribution provider 102 (e.g., Wegener's Compel and Control Network, etc.) via the communications network 104 (e.g., satellite communications, etc.) and the content server 302. The content server 302 provides the content to the IP to MPEG encapsulator 306 in IP format. The IP to MPEG encapsulator 306 converts the IP content to MPEG (e.g., MPEG-2, etc.) content which is then provided to the re-multiplexer 310. The re-multiplexer 310 then re-multiplexes the MPEG content with DTV program content (e.g., in DVB-ASI format, etc.) received from the stream converter 314.

The DTV program content is received via the receiver 316 (e.g., via satellite conmnunications, the Internet, an Intranet, wireless communications, telephony communications, a combination thereof, etc.) and provided to the stream converter 314 (e.g., in SMPTE310M format, etc.). The switch 312 selects either the re-multiplexed content from the re-multiplexer 310 or the DTV program content from the stream converter 314 and provides the content to the stream converter 308 (e.g., in DVB-ASI format, etc.). The stream converter 308 then provides the content to the high-power amplifier 304 (e.g., in SMPTE310M format, etc.).

The high-power amplifier 304 then provides the content to the transmitter 118 for distribution (e.g., at 19.4 Mbps). The local station studio 106 interfaces to the backchannel via the communications network 112 and signal lines 114. A central billing system 318 (e.g., implemented via an ISP) is coupled either directly to the local station studio 106 or coupled to the local station studio 106 via the communications network 112.

The system of FIGS. 1-3 allows for delivery of high quality new release movies, video games, MP3 files, etc., to the home via terrestrial broadcast. However, according to the present invention, the content could also be delivered over other communications means, such as satellite communications, wireless communications, etc., as will be appreciated by those skilled in the relevant art(s). Approximately 32 MPEG-2 or 127 MPEG-4 movies (and e.g., a hundred or more video games and MP3 files, etc.) are cached to the hard drive 220 of the set-top box 124 for viewing by the consumer at his or her leisure. However, other content could be distributed according to the present invention, such as catalogs, Web site content, software products, advertisements, etc., as will be appreciated by those skilled in the relevant art(s).

With respect to the content, licenses for the distribution of new release movie content may be obtained from the producers of the content. Such licenses may include a payment on a per-view basis or up-front prepaid licenses calculated based upon projected revenue (e.g., determined by “box office” draw). In addition, video store chains may be interested in pursuing VOD over terrestrial broadcast as it is advantageously more efficient with lower capital and operation costs, as compared to conventional delivery methods, such as VOD over DSL, cable, etc. Further, companies that provide VOD (e.g., streaming MPEG-4 video) via the Web and over DSL may be interested in content delivery according to the present invention. Such companies use a technique which can deliver 50 movies to 250 consumers on-demand via DSL (e.g., utilizing the SNET network). With such a technique, the content is cached to a point-of-presence (POP) and then streamed to a consumer as requested.

In addition, such companies, although presently not providing first run, new release movies, have significant familiarity with the movie industry and know what the movie content providers require in order to obtain licenses therefrom. Specifically, such companies can provide expertise, for example, with respect to (i) contract control (e.g., ensuring that the distribution, viewing and accounting is done in strict accordance with the particulars of the contract for each movie); (ii) territorial control (e.g., ensuring that the content is delivered only where it is intended; (iii) security management, such as (a) content protection (e.g., encryption), (b) transactional protection (e.g., ensuring that the content cannot be copied as a digital file while it is being played), (c) watermarking, etc.; (iv) market reporting (e.g., reporting for each movie when, where and how many times it was watched, trends, etc); (v) labeling (e.g., informing the consumer of the movie's viewer rating and providing required warnings for violence, nudity, language, etc.) and (vi) pursuing and negotiating licenses with the content providers.

Another option is to approach the content owners directly to establish a teaming relationship so that the content owners can bypass the retailer and deliver their content to the consumer directly. As ex-CEO of Viacom and ex-Chairman of Universal Studios, Frank Biondi, stated: “Almost universally [studios and labels] say, ‘We think we can do that ourselves.’ Their great dream is to get rid of the Blockbusters of the world, get rid of the theaters of the world, so they can capture the wholesale markup. What the industry has never liked is a retailer.” [2] Accordingly, since the movie studios already have the content, advantageously, they could provide their content directly to the consumer and by-pass the middleman, using the content distribution model according to the present invention.

With respect to distribution, according to the present invention, the content is distributed to the terrestrial broadcast stations 106 through the network 104. The present invention can distribute the content in encrypted form via the network 104 configured, for example, as a satellite network (using, e.g., Wegener's Compel Control network control system, Kencast's Fazzt Digital Delivery System, etc.) and/or other terrestrial mediums. Such methods enable secure (e.g., encrypted) delivery of content over satellite communications.

According to the present invention, the distribution of the content can be specific to each individual broadcast station 106, so that each individual broadcast station 106 can offer varying content (e.g., based upon demographics, some other need etc.), such as delivering location specific material for local broadcast (e.g., local add insertion via the content server 302). The content is received at each individual local broadcast station 106 from the network 104 in, for example, SMPTE310M format, is then converted to, for example, DVB-ASI and loaded onto the content server 302 of the local broadcast station 106. The loading of the content on to the server 302 and even the scheduling of the content for broadcast is all done remotely from a central facility 102 (e.g., utilizing Wegener's network control system, Kencast's network control system, etc). However, the present invention is applicable to any other content delivery mechanisms, as will be appreciated by those skilled in the relevant art(s).

The content server 302 moves the content (e.g., movies, MP3, video games, local advertisements, previews, etc.) from the source to a hard disk (e.g., of the content server 302) and encrypts the data during the write to the hard disk or encrypts the data on-the-fly when being carouseled out, for example. The content server 302 also breaks data up into suitable size blocks and applies Cyclic Redundancy Checking (CRC) to data blocks (i.e., files), for example. The content server 302 then schedules and carousels the data output stream to be re-multiplexed into the primary SDTV video transport stream utilizing the re-multiplexer 310. Local advertising may also be added in this way. According to the present invention, content, advertising, trailers, etc., are ‘tagged’ at the content server 302 to provide an identity therefor so that the set top box 124 can grab and play the content as requested and the trailers and advertisements on a predetermined schedule. In addition, such ‘tagged’ content allow for profiling of a consumer and targeting of advertisements and content specific to the consumer based on, for example, the type of content previously requested.

The content is then broadcast to a consumer's set-top box 124 where it is cached for viewing at the consumer's leisure. In order to ensure that the content is delivered in its entirety and without error, the content is broadcast on a carouseled basis so that any identified errors can be remedied on the subsequent broadcast. As new content is received by the content server 302, it is scheduled for multiple broadcasts in succession to insure that the complete file is received by the consumer. The new content is then scheduled into the regular carouseled broadcast schedule.

The broadcast in each region 120 is monitored for completeness to allow for error correction. If it is determined that a problem exists with the broadcast of a particular file, the content control and distribution provider 102 is notified and the content control and distribution provider 102 remotely amends the particular broadcast station's 106 content server 302 distribution schedule to provide for the re-broadcast of that file.

In addition, Kencast Fazzt Forward Error Correction (Fazzt FEC) solution which promises to deliver error free content can be employed as a content control and distribution provider 102. The Fazzt FEC is based upon on unique mathematical algorithms to correct for errors. At the receiver site 106, each packet is qualified as either received or lost. Missing packets are mathematically reconstructed using supplementary packets that were generated prior the transmission and broadcast with the original file or stream. Using this method, the broadcast period can be reduced, as a re-broadcast to overwrite defective packets would not be necessary.

The consumer receives the set-top box 124 pre-populated with content. The terrestrial broadcast according to the present invention updates the content in the set-top box 124 and adds new release content to the set-top box 124 as it becomes available. In this way, the consumer can view on demand all pre-populated and updated content in the set-top box 124. A calculation is made as to how old the content pre-populated on the set-top box 124 is at the time of sale to the consumer and then only content that is not already cached on the set-top box 124 is broadcast. The broadcast to the consumer can be done, for example, utilizing the full 19.4 Mbps of bandwidth available on off hours (i.e., 2-6 AM), utilizing the excess spectrum available during normal SDTV broadcasts, a combination thereof, etc. Content to completely re-populate an 80 GB hard drive 220 in the consumer's set-top box 124 can be cached via terrestrial broadcast, for example, over the periods indicated in Table 1 below.

TABLE 1
Content Population Broadcast Periods

| | |
|---|---|
| Time of Broadcast | Days Required to Broadcast All Content |

| | |
|---|---|
| Off Hours (four hours per night) | Three Days |
| On Hours (20 hours per day in | Three Days |
| conjunction with DTV broadcast | |
| presuming 4 Mbs average | |
| availability) | |
| Combination of On and Off | Less than 2 Days |
| Hours | |

The availability of bandwidth and particular demands and limitations of each broadcaster 106 determines what the broadcast delivery schedule will be. However, for example, both the Wegener Compel Control network system and the Kencast Fazzt Digital Delivery System provide the flexibility to allow and control broadcast station 106 specific broadcast schedules.

Table 2 below sets forth the time it would take to broadcast various content and the amount of content that could be cached to an 80GB hard drive 220 of the set-top box 124.

TABLE 2
Content Population Times

| | | | | Download | Time | | | |
|---|---|---|---|---|---|---|---|---|
| | | Mem. | Mem. | time for | to fill | | # MP3s/ | # movies |
| | Data | for 1 Hr. | For 1 | one | 80 GB | # movies | Games | cached |
| Video | Rate | program | movie¹ | movie² | HD | download | Per | on 80 GB |
| Format | [MBPS] | [MB] | [MB] | [Mins.] | [Hrs.] | per hour | movie³ | HD |
| MPEG2 | 4 | 1440 | 2520 | ˜21.6 | ˜11.5 | ˜2.7 | 100.8/ | ˜32 |
| @ 19.4 | | | | | | | 630 | |
| Mbps | | | | | | | | |
| MPEG4 | 1 | 360 | 630 | ˜5.4 | ˜11.5 | ˜11 | 25/ | ˜127 |
| @ 19.4 | | | | | | | 157.5 | |
| Mbps | | | | | | | | |

Notes:
¹One movie = 1.75 Hr.;
²One Byte = 10 bits; and
³One MP3 audio file = 4 Mbytes, and one Video Game = 25 Mbytes.

The multiplexed content is then broadcast by each local station 106 and received by the set-top box 124 via the antenna 202 (e.g., using 8-VSB modulation, COFDM modulation, etc., as taught in U.S. Provisional Patent Application Number 60/216,769) In a case where the content is transmitted to the set-top box 124 via satellite communications, the antenna 202 is replaced by a satellite dish.

In addition to demodulation of a DTV signal, the receiver 214 of the set-top box 124 (e.g., seated in PCI slot of the set-top box 124) is capable of identifying a “data” portion of a broadcast and separating such data from a DTV program (e.g., in standard format, high definition format, etc). Accordingly, receivers that have a data handling capability (e.g., Triveni, BroadLogic, Hauppauge, etc.) may be used as the receiver 214, according to the present invention. In addition, such receivers may be integrated with an encryption system (e.g., Wave System Embassy encryption system, etc.). The data portion of the received signal is then cached to the set-top 124 hard disk 220 as it is received.

The receiver 214 receives data in carouseled blocks with a CRC value attached to each block. The receiver 214 (e.g., integrated into the set-top box 124, implemented as a separate set-top box, etc.) software performs a CRC check on the received data blocks (i.e., files) and creates a data-block database identifying corrupt CRC blocks. Data-blocks that are tagged as corrupt in the database and are over-written by a subsequent transmission of the same block (i.e., given a valid CRC check), as the data is repeatedly sent in the carousel.

The set-top box 124 includes “intelligence” implemented via the software 210 to monitor viewing habits of an individual customer (e.g., by assigning values for each item of content which indicate the receptiveness of a customer to certain products, etc.). The set-top box 124 then selects, for example, those advertisements and trailers that would be most effective on, and pertinent to, that customer. All such information is then anonymously reported back to the central billing server 318 as feedback to advertisers and content providers to assist in selling adds and trailers. To increase disk storage efficiency, all advertisements and trailers are broadcast, but only the advertisements and trailers appropriate for the individual customer(s) are cached to the set-top box 124 (e.g., with the “intelligence” feature making the determination, etc.). As parental controls are provided to keep children from having access to inappropriate content, the present invention enables, for example, presentation of R rated advertisements in conjunction with R rated movies. As these advertisements and trailers have entertainment value in and of themselves, advertisements and/or trailers can be placed at the end of movies, games, etc., as well as at the beginning thereof. In addition, such advertisements and trailers may ‘pop-up’ whenever a movie, game, etc., is paused, unless the pause button is held down for a predetermined period in which case a still screen image is displayed.

With respect to providing user interaction, the set-top box 124 includes the operating system (OS) with specific software applications resident on the set-top box 124 hard disk 220. The highest level of the software architecture 210 includes a Graphical User Interface (GUI) presented on the television 122 or the data device 126 and that the consumer interacts with via the peripheral device 206 (e.g., a standard infrared (IR) remote control unit, etc.).

Through the GUI, the consumer is given control of all features and functionality. For example, a “Media Selection” GUI screen presents the consumer with a listing of all the content currently cached in the hard disk 220 and available for viewing. The GUI also provides a pre-view option and a complete set of disk utilities to allow the consumer to select or delete any of the cached content from the hard disk 220.

Selecting a desired movie, game, MP3 file, etc., is as simple as scrolling to the desired content and clicking a button on the peripheral device 206. A purchase confirmation pop-up box appears to reconfirm that the media selected is desired. If the media selected was previously “purchased” and the allotted viewing time has not yet run out, the selected media will still have a valid decryption key and the consumer is informed of the same and the remaining usage time is displayed. If this is a new selection (or time has expired) the consumer is shown the purchase price and allotted duration of usage in a confirmation pop-up window. If parental control spending limits, as discussed below, are imposed, the media selection may be denied.

Companies, such as MeTV, etc., appear to have internally developed software to perform the majority of the above-noted functions and a possibility of teaming or subcontracting with such companies is feature of the present invention.

All rental requests, conditional access, usage and billing mechanics occur automatically, behind the scenes. An initial dial-up to the central billing system 318 is needed at the time of connection of the set-top box 124 to provide a security activation key. The decryption key provides continued usage capability of the media for the duration of the key's timestamp (e.g., 24 hours, 30 days, one-time usage, etc.).

When the consumer makes a selection, an inquiry is made into a billing database of the set-top box 124 to determine if a valid decryption key exists for the particular media chosen. If a valid decryption key exists for the media selected, the media is decrypted on-the-fly from the hard drive 220 as it is streamed (i.e., recall that the media downloaded is encrypted at the head-end and remains so on the set-top box 124 hard drive 220). If the designated time has expired since the last request to obtain the decryption key there will not be a current valid decryption key for this media in the billing database and the billing software automatically connects to the central billing system 318 via the network 112 to request a new decryption key (e.g., via dial-up using a modem connection, DSL modem connection, cable modem connection, etc.).

Whenever a new key is acquired, the billing database is updated with the specific key information (e.g., which movie, video game, etc., to unlock and for how long). The billing database is also used to manage and track account usage information. This information is periodically communicated to the central billing system 318 (e.g., via dial-up using a modem connection, DSL modem connection, cable modem connection, etc., during off hours).

With the physical limitations of the size of the set-top box 124 hard disk 220 comes the need to discard currently cached content as new content is received (i.e., newly released videos, games, etc). The process of “over-writing” the existing content is dictated by the consumer's preference. In this way, a favorite game or commonly watched video can remain locally cached in the set-top box 124 for an extended period of time.

On request, a “Favorites” GUI screen presents the consumer with a list of currently cached content. The consumer simply highlights the content that they wish to keep, ensuring that the “other” content is overwritten first. Alternatively, the consumer may select a protocol, such as First In First Out (FIFO), etc., or direct the set-top box 124 to overwrite content based upon categories (e.g., such as “eliminate all Horror films or films with offensive language first,” etc.).

According to the present invention, the content is broadcast, for example, in both an MPEG-2 and an MPEG-4 signal. In this way, users may receive in MPEG-4 to get higher selection and switch to MPEG-2 for higher quality. The users has the option of toggling between the two options via, for example, the set-top box 124 GUI. As the user can control the content overwrite functions, the user can determine which movies, games, etc., to keep (and, e.g., in what format, etc.) and which ones to discard. A program schedule is broadcast with the content to inform the user via, for example, the set-top box 124 GUI of what content is available in each format.

The GUI also provides a “Parental Control” screen with menus to restrict (e.g., password protect) access to certain content and set spending limits. All content is pre-classified (e.g., by embedded metadata) by categories of language, nudity, violence, etc., as well as tagged with a parental guidance rating. Another feature of the GUI is, for example, an “Account Information” screen that provides current billing information, content-specific key usage time remaining, billing database information, etc. Additionally, the software 210 consists of custom drivers for additional consumer interface peripherals (e.g., game controls, etc.), as discussed below.

The set-top box 124 architecture includes the hard drive 220 (e.g., a standard Integrated Drive Electronics (IDE) hard drive, etc.). At this time, the largest known IDE hard drive available is 80 GB. However, multiple drivers could be used to increase capacity and a largest hard drive size available at the time the set-top box is built could be used. The hard drive 220 stores, for example, the set-top box 124 operating system, graphical user interface code, content that is broadcast out and to be cached on the set-top box 124, etc. The capacity of the hard drive 124 directly relates to number of movies, video games, MP3s, any future content, etc., that can be cached on the set-top box 124. This means that “bigger is better” and the only limitation in the future to the capacity of the hard drive 220 in the set-top box 124 would be typically based on cost.

The power supply 222 (e.g., a standard 120/240 volt power supply) required wattage is determined by the load of the internal peripherals and includes low noise cooling features. The motherboard 216 is any motherboard suited to interface with all peripherals of the set-top box 124 (e.g., a standard Micro-ATX motherboard, PC104 (PC on a card), ‘manufactured to suit’ type board, etc.).

The following are exemplary devices and features of the set-top box 124: (1) A greater than or equal to 500 megahertz processor (e.g., AMD, Intel, Cyrix, etc.); (2) Greater than or equal to 64 megabytes of memory; (3) Greater than or equal to 2 available PCI slots; (4) One of the PCI slots may be used to support the receiver 214 (e.g., in the form of a card, discrete/custom device(s), etc.) and the other PCI slot reserved for future use; (5) Integrated IDE controller; (6) Integrated Universal Serial Bus (USB) controller (e.g., to support future add on peripherals, to provide additional functionality, etc.); (7) Integrated standard serial port controller (e.g., 16550 UART, etc.); (8) Integrated infrared/RF controller (e.g., used to support wireless remote control, wireless keyboard, wireless mouse, etc.); (9) Integrated Video Graphics Array (VGA) controller (e.g., to provide video information to the data device 126); (10) Integrated composite video port controller (e.g., used as a video output channel to the television 122 if dual-piping is not supported by the receiver 214, etc); (11) Integrated 10/100 Network Interface Card (NIC) controller (e.g., used to support backchannel communications to the point-of-presence (POP), etc.); (12) Integrated V.90 56K Modem (e.g., used to support back-channel communications to the point-of-presence (POP), etc.); (13) Integrated IEEE1394 Digital Video (DV) controller (e.g., used to support future add-on peripherals, to provide additional functionality, etc.); (14) Integrated parallel port controller (e.g., used to add printing capabilities, etc., to the set-top box 124); (15) Integrated keyboard/mouse port controller (e.g., the keyboard and mouse controls may be accomplished with infrared type peripherals but most motherboard options include these ports); (16) Integrated floppy drive controller (e.g., used to support future in-field upgrades, etc., to the set-top box 124); (17) Integrated audio controller (e.g., used as an audio output channel to the television 122 and/or the data device 126, used as amplifier if dual-piping is not supported by the receiver 214, etc.); (18) The receiver 214 configured to receive and demodulate a modulated signal (e.g., a DTV signal, etc.), separate content information from television program information from the received signal, store the content information to the hard drive 220, read the content information from the hard drive 220, convert MPEG content to an analog/digital output for display on the television 122 (e.g., standard/HDTV television using either s-video, standard composite type outputs, HDTV outputs, etc.) and/or the data device 126, and decode AC3 audio output.

The receiver 214 can then be connected to either a standard television or stereo amplifier, receive a DTV signal and output the signal in an analog/digital format to a standard/HDTV television 122, data device 126, etc. The receiver 214 and may be implemented via a receiver card (e.g., BroadLogic, Hauppauge, Triveni, etc.).

The software 210 includes, for example, the Operating System (OS, e.g., 20MB), Graphical User Interface (GUI, e.g., 5MB), etc. The operating system for the set-top box 124 may be based on, for example, a Linux implementation of Unix, Windows CE, Palm OS, etc. The software 210 operates behind the scenes and tracks, for example, the set-top box 124 usage, security, content, billing, backchannel communications, etc. The GUI discussed above interfaces between the consumer and the set-top box 124 software 210.

The backchannel interface 218 provides backchannel communications between the set-top box 124 and the point-of-presence (POP, e.g., the network 112). Exemplary backchannel interfaces 218 include: (1) analog modem (e.g., via a PSTN allowing dialing a local or toll-free access number to transfer information back and forth between the point-of-presence and the set-top box 124, etc., the communication occurring during “off hours” as to not interfere with normal operation of the consumer's telephone line); (2) cellular modem (e.g., allowing dialing a local or toll-free access number to transfer information back and forth between the point-of-presence and the set-top box 124, etc., the communication occurring at anytime because it is based off a wireless implementation and would not require a consumer supplied telephone line); (3) LAN/WAN via cable modem or DSL (e.g., allowing an “always on” type connection that would allow for communication between the point-of-presence and the set-top box 124, etc., the communication occurring at anytime); (4) custom transceiver (e.g., allowing an “always on” type connection and would allow for communication between the point-of-presence and the set-top box 124 to occur at anytime); and (5) use of the UHF Guard Band (e.g., as owned by Pegasus, etc.).

Any of the above and other implementations (e.g., satellite communications, etc.) suitable to accomplish backchannel communications due to the relatively small amount of data that need to be transferred may be used according to the present invention. The set-top box 124 software 210 automatically and periodically connects to (e.g., dials-up, etc.) the central billing system 318 to upload the usage and billing information. According to the present invention, the backchannel communication are not limited, but may be any implementation capable of operation with the set-top box 124.

The FCC currently requires that one free video signal of NTSC quality or better, which amounts to only twenty percent of the potential payload, be provided by the licensee broadcaster 106. The remaining video signals can be used to provide any lawful service a licensee chooses, including the transport of data for pay. Specifically, pay video services are permitted if they are ancillary to the required free service.[3] The FCC has determined that a five percent Digital Television (DTV) ancillary fee must be paid on all revenues received from transmitting other entities' data.

Licensees are required to file a return and make payment each December 1 for the year ending on the previous September 30.[3] The cost of the set-top box 124 to the consumer will be nominal (e.g., $100-170, since the cost of the set-top box 124 may be subsidized). Revenue is generated from rental fees, subscription fees, trailer promotion fees, local advertising fees, sale of other products, etc. In any case, the cost of the set-top box 124, or the ‘penalty’ for not returning the set-top box 124, is set sufficiently high to make it economically undesirable for people to obtain the set-top box 124 for the purpose of cannibalizing components thereof.

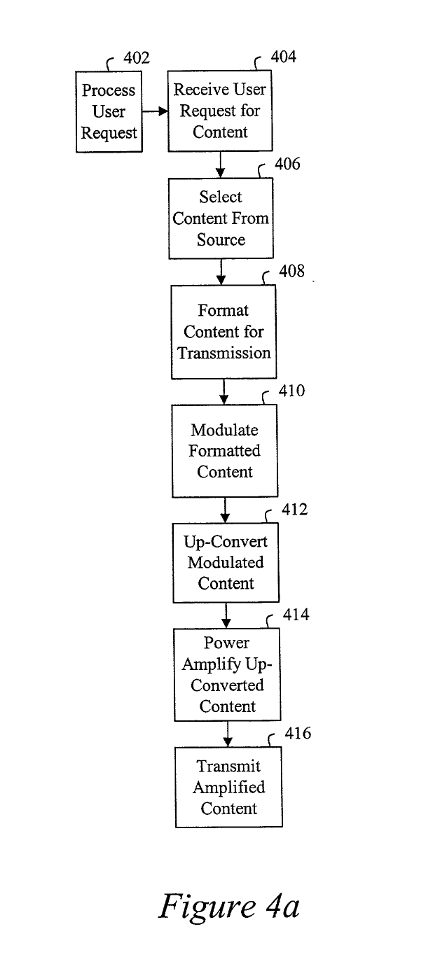

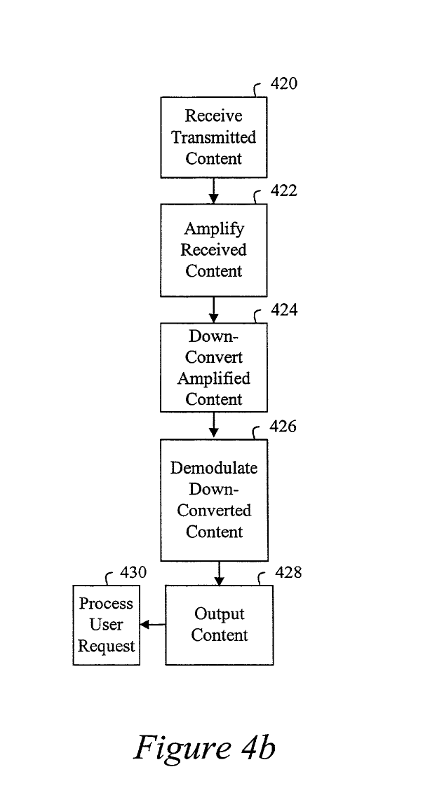

FIG. 4a is a flow chart illustrating the content transmission scheme for the system of FIGS. 1-3, according to the present invention. In FIG. 4a, at step 402, a content request is processed via the backchannel (elements 218, 114, 112 and 106). At step 404, the content request is received and the requested content is selected via the switch 312 at step 406. At step 408, the content is formatted by the stream converter 308. At step 410, the content is modulated and then up-converted at step 412. Power-amplifying the up-converted content at step 414 and transmitting the amplified content at step 416 complete the process.

FIG. 4b is a flow chart illustrating the reception scheme for the system of FIGS. 1-3, according to the present invention. The reception scheme is an inverse of the transmission scheme and includes receiving the modulated content at step 420, amplifying the received content at step 422, down-converting the amplified content at step 424, and demodulating the down-converted content at step 426 via the set-top box 124. The content is sent to the data device 126 and/or TV 122 at step 428 and content requests are processed at step 430, completing the process.

The model of content distribution according to the present invention is less costly than a video store model given the cost to build rental stores in each community and pay for employees, utilities and video tape distribution. In addition, the present invention is less expensive than delivery over DSL (however, DSL may have an advantage in densely populated areas).

The biggest competition for terrestrial broadcast content distribution may be satellite content distribution or digital cable content distribution, given that a similar set-top box 124 that can cache video may be used. For example, Insight Communications, Inc. offers VOD as part of a digital platform in Indiana, Ohio and Illinois. Insight Communications, Inc. represents that they offer ‘hundreds’ of movies accessed with a remote control and on-screen navigator with the pause, rewind and fast forward functionality of a VCR.

However, not all cable systems are digital and they would not likely offer VOD service as a standalone given its cost (i.e., such models will have limited market penetration). A satellite model might be efficient, as satellite delivers a huge distribution footprint, but satellite has the disadvantages of not being able to insert local content and advertising, the cost to purchase and install a dish, satellite receiver, plus the set-top box is cost prohibitive, and installing a dish is inconvenient for the customer.

In contrast, the present invention allows for local advertisement insertion via, for example, the content server 302 and therefore allow for supplemental revenue. It all comes down to “who has the most cost efficient system” and terrestrial broadcast is a uniquely efficient way to multicast content.

The primary benefit of the present invention model is that it allows the consumer to view, for example, new release movies, games, MP3, etc., when they want (i.e., true Video on Demand) and as often as they want, without having to leave the comfort of their home. The present invention recognizes major disadvantages of renting movies from video stores, such as: (1) video stores have limited hours so the consumer often cannot obtain a movie for viewing when they find that they have the opportunity to do so (and revenue opportunity is lost); (2) the consumer often has a limited selection as new release movies are often sold out at the video stores; (3) the consumer must pay late fees if he is unable to physically return the movie in the time allotted by the video store; and (4) the consumer must pay additional fees if the video tape is returned without being rewound.

The present invention eliminates all of these disadvantages by making the content available to each consumer at home when they want it. It also provides the significant additional benefit of providing the consumer DVD+video quality and 5.1 Channel AC3 audio quality that is currently unavailable unless the consumer rents DVDs (i.e., assuming the broadcast is of MPEG-2 content).

However, the present invention system duplicates the advantages video stores provide through video tape rentals; the flexibility to start, pause, stop, rewind and play movie content at the viewer's discretion as many times as the viewer desires during the allotted ‘purchase’ period. Cable and satellite NVOD are unable to provide these features.

As previously mentioned, the set-top box 124 with the 80 GB hard drive 220 typically can hold up to 32 MPEG-2 or 127 MPEG-4 movies. It is recognized that the significant majority of a video store's revenue comes from the rental of a relatively small number of new release movies. The trading off of quality (MPEG-2) against quantity (MPEG-4) or vice versa may be determined using cost-benefit analysis. However, in either format, present invention can provide video quality as good as, or better than, VHS quality as delivered by video rental stores, digital cable, DSL, etc.

The present invention advantageously provides convenience to the consumer. As the world is today, consumers must get in their car and drive to their local video stores (i.e., presuming the stores have not yet closed). Maybe the new release movies they want are available; maybe they are not and they have to settle for a second or third choice. This is not ideal, but perhaps it is better than ordering pay-per-view over cable or satellite because cable and satellite movie selection is poor, the consumer has to be there to watch the movie when it is scheduled, and the consumer can't pause the movie at their convenience. The following day (or maybe they are lucky and have a couple of days) the consumer must either drive back to the video store and return the movie or pay late fees. And if they did not rewind the tape, they may have to pay additional rewind fees. With the present invention, the consumer gets higher quality entertainment with significantly less inconvenience. These realities may seem to be small nuances, but they are the distinguishing features of why one model will be preferred over another model.

The present invention stores information relating to various processes described herein. This information is stored in one or more memories, such as a hard disk, optical disk, magneto-optical disk, and/or RAM, for example. One or more databases, such as databases provided in the hard drive 220, the content server 302, etc., may store the information used to implement the present invention. The databases are organized using data structures (e.g., records, tables, arrays, fields, graphs, trees, and/or lists) contained in one or more memories, such as the memories listed above or any of the storage devices listed below in the discussion of FIG. 5, for example.

The previously described processes include appropriate data structures for storing data collected and/or generated by the processes of the system 100 in one or more of databases. Such data structures accordingly will includes fields for storing such collected and/or generated data.

All or a portion of the invention may be conveniently implemented using conventional general purpose computers or microprocessors programmed according to the teachings of the present invention, as will be apparent to those skilled in the computer art. Appropriate software can be readily prepared by programmers of ordinary skill based on the teachings of the present disclosure, as will be apparent to those skilled in the software art.

FIG. 5 illustrates a computer system 501 upon which embodiments of the present invention may be implemented (e.g., the computer system 501 may used in implementing elements 102, 106, 108, 124, 126, 122, 302, 306, 318, etc.) The computer system 501 maybe any one of a personal computer system, a work station computer system, a laptop computer system, an embedded controller system, a microprocessor-based system, a digital signal processor-based system, a hand held device, a personal digital assistant (PDA) device, an Internet appliance device, a set top box device, a cellular telephone device, etc.

The computer system 501 includes a bus 503 or other communication mechanism for communicating information, and a processor 505 (e.g., one or more general-purpose processors, digital signal processors, etc.) coupled with bus 503 for processing the information. The computer system 501 also includes a main memory 507, such as a random access memory (RAM) or other dynamic storage device (e.g., dynamic RAM (DRAM), static RAM (SRAM), synchronous DRAM (SDRAM), flash RAM), coupled to bus 503 for storing information and instructions to be executed by processor 505. In addition, main memory 507 may be used for storing temporary variables or other intermediate information during execution of instructions to be executed by processor 505.

The computer system 501 further includes a read only memory (ROM) 509 or other static storage device (e.g., programmable ROM (PROM), erasable PROM (EPROM), and electrically erasable PROM (EEPROM)) coupled to bus 503 for storing static information and instructions for processor 505. A storage device 511, such as a magnetic disk or optical disk, is provided and coupled to bus 503 for storing information and instructions.

The computer system 501 also include the receiver 214 (e.g., provided as a card, in discrete/custom device form, off-the-shelf receiver card form, etc.), for example, including special purpose logic devices (e.g., application specific integrated circuits (ASICs)) or configurable logic devices (e.g., generic array of logic (GAL) or re-programmable field programmable gate arrays (FPGAs)) for performing special purpose functions (e.g., speech signal processing, image signal processing, digital signal processing, modulation, demodulation, etc.). Other removable media devices (e.g., a compact disc, a tape, and a removable magneto-optical media) or fixed, high-density media drives may be added to the computer system 501 using an appropriate device bus (e.g., a small computer system interface (SCSI) bus, an enhanced integrated device electronics (IDE) bus, or an ultra-direct memory access (DMA) bus). The computer system 501 may additionally include a compact disc reader, a compact disc reader-writer unit, or a compact disc jukebox, each of which may be connected to the same device bus or another device bus.

The computer system 501 may be coupled via bus 503 to a display 513, such as a cathode ray tube (CRT), liquid crystal display (LCD), standard/HDTV television monitor, etc., for displaying information to a user and implementing the man-machine interface (MMI) or the graphical user interface (GUI). The display 513 may be controlled by a display or graphics card. The computer system includes input devices, such as a keyboard 515 and a cursor control 517, for communicating information and command selections to processor 505.

The cursor control 517, for example, is a mouse, a trackball, IR remote control, cursor direction keys, etc., for communicating direction information and command selections to processor 505 and for controlling cursor movement on the display 513. In addition, a printer may provide printed listings of the data structures/information of the system 100 or any other data stored and/or generated by the computer system 501.

The computer system 501 performs a portion or all of the processing steps of the invention in response to processor 505 executing one or more sequences of one or more instructions contained in a memory, such as the main memory 507. Such instructions may be read into the main memory 507 from another computer readable medium, such as storage device 511. One or more processors in a multi-processing arrangement may also be employed to execute the sequences of instructions contained in main memory 507. In alternative embodiments, hard-wired circuitry may be used in place of or in combination with software instructions. Thus, embodiments are not limited to any specific combination of hardware circuitry and software.

As stated above, the system 501 includes at least one computer readable medium or memory programmed according to the teachings of the invention and containing data structures, tables, records, or other data described herein. Examples of computer readable media are compact discs, hard disks, floppy disks, tape, magneto-optical disks, PROMs (EPROM, EEPROM, Flash EPROM), DRAM, SRAM, SDRAM, etc. Stored on any one or on a combination of computer readable media, the present invention includes software for controlling the computer system 501, for driving a device or devices for implementing the invention, and for enabling the computer system 501 to interact with a human user (e.g., users of the system 100). Such software may include, but is not limited to, device drivers, operating systems, development tools, and applications software. Such computer readable media further includes the computer program product of the present invention for performing all or a portion (if processing is distributed) of the processing performed in implementing the invention.

The computer code devices of the present invention may be any interpreted or executable code mechanism, including but not limited to scripts, interpreters, dynamic link libraries, Java classes, database stored procedures and complete executable programs. Moreover, parts of the processing of the present invention may be distributed for better performance, reliability, and/or cost.

The term “computer readable medium” as used herein refers to any medium that participates in providing instructions to processor 505 for execution. A computer readable medium may take many forms, including but not limited to, non-volatile media, volatile media, and transmission media. Non-volatile media includes, for example, optical, magnetic disks, and magneto-optical disks, such as storage device 511. Volatile media includes dynamic memory, such as main memory 507. Transmission media includes coaxial cables, copper wire and fiber optics, including the wires that comprise bus 503. Transmission media also may also take the form of acoustic or light waves, such as those generated during radio wave and infrared data communications.

Common forms of computer readable media include, for example, hard disks, floppy disks, tape, magneto-optical disks, PROMs (EPROM, EEPROM, Flash EPROM), DRAM, SRAM, SDRAM, or any other magnetic medium, compact disks (e.g., CD-ROM), or any other optical medium, punch cards, paper tape, or other physical medium with patterns of holes, a carrier wave (described below), or any other medium from which a computer can read.

Various forms of computer readable media may be involved in carrying out one or more sequences of one or more instructions to processor 505 for execution. For example, the instructions may initially be carried on a magnetic disk of a remote computer. The remote computer can load the instructions for implementing all or a portion of the present invention remotely into a dynamic memory and send the instructions over a telephone line using a modem. A modem local to computer system 501 may receive the data on the telephone line and use an infrared transmitter to convert the data to an infrared signal. An infrared detector coupled to bus 503 can receive the data carried in the infrared signal and place the data on bus 503. Bus 503 carries the data to main memory 507, from which processor 505 retrieves and executes the instructions. The instructions received by main memory 507 may optionally be stored on storage device 511 either before or after execution by processor 505.

The computer system 501 also includes a communication interface 519 coupled to bus 503. The communication interface 519 provides a two-way data communication coupling to a network link 521 that may be connected to, for example, a local network 523 (e.g., to implement the backchannel, etc). For example, communication interface 519 may be a network interface card to attach to any packet switched local area network (LAN). As another example, communication interface 519 may be an asymmetrical digital subscriber line (ADSL) card, an integrated services digital network (ISDN) card or a modem to provide a data communication connection to a corresponding type of telephone line. Wireless links may also be implemented. In any such implementation, communication interface 519 sends and receives electrical, electromagnetic or optical signals that carry digital data streams representing various types of information.

The network link 521 typically provides data communication through one or more networks to other data devices. For example, network link 521 may provide a connection to a computer 525 through local network 523 (e.g., a LAN) or through equipment operated by a service provider, which provides communication services through a communications network 527. In preferred embodiments, local network 523 and communications network 527 preferably use electrical, electromagnetic, or optical signals that carry digital data streams. The signals through the various networks and the signals on network link 521 and through communication interface 519, which carry the digital data to and from computer system 501, are exemplary forms of carrier waves transporting the information. The computer system 501 can transmit notifications and receive data, including program code, through the network(s), network link 521 and communication interface 519.

Although the present invention is described in terms of application to wireless terrestrial communication systems, the present invention may be applied to other types of communication systems, such as satellite communication systems, network communication systems, etc., as will be appreciated by those skilled in the relevant art(s).

Although the present invention is described in terms of providing an external set-top box 124, such functionality could be integrated into the televisions 122, the data devices 126, DSL modems, cable modems, telephone modems, etc., as will be appreciated by those skilled in the relevant art(s).

Although the present invention is described in terms of providing a backehannel via the communications network 112, the backchannel could be provided via cable modem, DSL modem, satellite communications, pager networks, cellular networks, microwave comnunications, etc., as will be appreciated by those skilled in the relevant art(s).

Although the present invention is described in terms of providing backchannel using TCP/IP, other protocols could be used, such as Serial Line Internet Protocol (SLIP), Point-to-Point Protocol (PPP), User Datagram Protocol (UDP), Internet Control Message Protocol (ICMP), Interior Gateway Protocol (IGP), Exterior Gateway Protocol (EGP), Border Gateway Protocol (BGP), etc., as will be appreciated by those skilled in the relevant art(s).

Accordingly, in light of the above teachings, numerous modifications and variations of the present invention are possible in the spirit of the present invention. It is therefore to be understood that within the scope of the appended claims, the invention may be practiced otherwise than as specifically described herein.

### List of References

[1] <http://www4.enron-com/corp/pr/releases/2000/ec/68-Blockbuster.html>

[2] RED HERRING MAGAZINE, Entertaining Thoughts, Interview with Frank Biondi and Peter Dekon, by Robert La Faranco, Nov. 13, 2000.

[3] BROADCAST ENGINEERING, Datacasting: Is it Legal?, as written by Mitchell Lazarus, Esq., an attorney with Fletcher, Heald & Hildreth, PLC, July 2000.

What is claimed as new and desired to be secured by Letters Patent of the United States is:

1. A system for distributing content over a terrestrial broadcast channel, comprising:
a broadcast station configured to transmit over said terrestrial broadcast channel a television signal including encrypted updated content information, distributed at least one of nationally and locally, and television information to all users within a broadcast coverage area; and
an apparatus pre-configured to include encrypted predetermined content information stored therein prior to acquisition of said apparatus by a user and configured to:
receive over said terrestrial broadcast channel said television signal,
extract said encrypted updated content information from said television signal,
store said encrypted updated content information in said apparatus,
decrypt said updated encrypted content information and said encrypted predetermined content information, and
provide on demand at least one of said decrypted updated content information and said decrypted predetermined content information in a format for at least one of a television, a data processing device and a gaming device,
wherein said encrypted updated content information and said encrypted predetermined content information includes at least one of encrypted digital movies, encrypted video games and encrypted MPEG Audio Layer 3 (MP3) files.

2. The system of claim 1, wherein said broadcast station is configured generate said encrypted updated content information before transmission via said television signal.

3. The system of claim 1, wherein said broadcast station comprises a content server configured receive updated content information from a content control and distribution system, generate said encrypted updated content information and store said encrypted updated content information therein.

4. The system of claim 3, wherein said broadcast station comprises a digital television signal (DTV) receiver configured to receive a DTV signal over a DTV communications network.

5. The system of claim 4, wherein said DTV communications network is configured as one of a cellular communications network, a satellite communications network, a digital subscriber line (DSL) communications network, a cable modem communications network, a modem communications network and a telephony communications network.

6. The system of claim 4, wherein said broadcast station comprises a multiplexer configured to multiplex said DTV signal from said DTV receiver with said encrypted updated content information from said content server and output the multiplexed information.

7. The system of claim 6, wherein said content server is configured to insert information local to said broadcast coverage area with said DTV signal via said multiplexer.

8. The system of claim 6, wherein said broadcast station comprises a switch configured to output one of said multiplexed information from said multiplexer and said DTV signal from said DTV receiver as selection output information.

9. The system of claim 8, wherein said broadcast station comprises a transmitter configured to transmit said selection output information from said switch as said television signal.

10. The system of claim 1, further comprising:
a content control and distribution system configured to transmit updated content information to said broadcast station via a content control and distribution communications network.

11. The system of claim 10, wherein said content control and distribution communications network is configured as one of a cellular communications network, a satellite communications network, a digital subscriber line (DSL) communications network, a cable modem communications network, a modem communications network and a telephony communications network.

12. The system of claim 1, wherein said apparatus is configured to include a backchannel interface enabling two-way communications with said broadcast station over a backchannel communications network.

13. The system of claim 12, wherein said backchannel interface is configured to transmit at least one of user content selection information and billing information to said broadcast station over said backchannel communications network,
wherein said broadcast station is configured to use said content selection information is to generate content decryption information.

14. The system of claim 13, further comprising a backchannel server configured to transmit at least one of said user content selection information and said billing information from said backchannel interface to said broadcast station one of directly and over said backchannel communications network.

15. The system of claim 13, wherein said backchannel interface is configured to receive at least one of said content decryption information and billing information from said broadcast station over said backchannel communications network,
wherein said apparatus is configured to use said content decryption information to decrypted said encrypted updated content information and said encrypted predetermined content information.

16. The system of claim 15, further comprising a backchannel server configured to transmit at least one of said content decryption information and said billing information from said broadcast station to said backchannel interface over said backchannel communications network.

17. The system of claim 12, wherein said backchannel communications network is configured as one of a cellular communications network, a satellite communications network, a digital subscriber line (DSL) communications network, a cable modem communications network, a modem communications network and a telephony communications network.

18. The system of claim 12, wherein said backchannel communications network is configured to communicate over the Internet.

19. The system of claim 1, wherein said apparatus comprises one of a personal computer system, a work station computer system, a laptop computer system, an embedded controller system, a microprocessor-based system, a digital signal processor-based system, a hand held device, a personal digital assistant (PDA) device, an Internet appliance device, a set top box device, a cellular telephone device.

20. The system of claim 1, wherein said television comprises one of a standard television and a high definition television.

21. The system of claim 1, wherein said data processing device comprises one of a personal computer system, a work station computer system, a laptop computer system, an embedded controller system, a microprocessor-based system, a digital signal processor-based system, a hand held device, a personal digital assistant (PDA) device, an Internet appliance device, a set top box device, a cellular telephone device.

22. The system of claim 1, wherein local information is inserted at the beginning or end of at least one of said updated content information and said predetermined content information.

23. The system of claim 22, wherein tag information is inserted at the beginning or end of at least one of said updated content information and said predetermined content information.

24. The system of claim 23, wherein said tag information is used by said apparatus to track content viewing habits.

25. The system of claim 23, wherein said tag information is used by said apparatus to determine said local information insertion.

26. The system of claim 25, wherein said local information insertion corresponds to a rating of content.

27. The system of claim 22, wherein said local information is provided by said apparatus whenever content is paused by a user of said apparatus.

28. The system of claim 27, wherein a paused version of content is provided by said apparatus whenever content is paused by a user of said apparatus for a predetermined amount of time.

29. The system of claim 1, wherein decrypted content is provided to a user for a predetermined period after a user pays for selected content via said apparatus.

30. The system of claim 1, wherein said digital movies are provided in at least one of MPEG-2 and MPEG-4 formats.

31. The system of claim 1, wherein said digital movies are provided in at least one of MPEG-2 and MPEG-4 formats via selection by a user via said apparatus.

32. The system of claim 1, wherein said apparatus includes a port configured to couple said apparatus to a gaming device.

33. A process for distributing content over a terrestrial broadcast channel comprising steps of:
transmitting from a broadcast station over said terrestrial broadcast channel a television signal including encrypted updated content information, distributed at least one of nationally and locally, and television information to all users within a broadcast coverage area;
encrypting in an apparatus predetermined content information stored therein prior to acquisition of said apparatus by a user;
receiving over said terrestrial broadcast channel said television signal;
extracting said encrypted updated content information from said television signal;
storing said encrypted updated content information in said apparatus;
decrypting said updated encrypted content information and said encrypted predetermined content information; and
providing on demand at least one of said decrypted updated content information and said decrypted predetermined content information in a format for at least one of a television, a data processing device and a gaming device,
wherein said encrypted updated content information and said encrypted predetermined content information includes at least one of encrypted digital movies, encrypted video games and encrypted MPEG Audio Layer 3 (MP3) files.
